(19) United States
(12) Patent Application Publication
(10) Pub. No.: US 2015/0363333 A1
(43) Pub. Date: Dec. 17, 2015

(54) HIGH PERFORMANCE AUTONOMOUS HARDWARE ENGINE FOR INLINE CRYPTOGRAPHIC PROCESSING

(71) Applicant: Texas Instruments Incorporated, Dallas, TX (US)

(72) Inventors: William C. Wallace, Richardson, TX (US); Amritpal S. Mundra, Allen, TX (US)

(21) Appl. No.: 14/305,739

(22) Filed: Jun. 16, 2014

(51) Int. Cl. G06F 12/14; G06F 13/28

(52) U.S. Cl. CPC G06F 12/1408; G06F 13/28; G06F 2212/1052

(57) ABSTRACT

A real time, on-the-fly data encryption system is shown operable to encrypt and decrypt the data flow between a secure processor and an unsecure external memory system. Multiple memory segments are supported, each with its own separate encryption capability, or no encryption at all. A Message Authentication Code is also employed to detect any memory corruption or unauthorized memory modification.

### BACKGROUND OF THE INVENTION

Many emerging applications require physical security as well as conventional security against software attacks. For example, in Digital Rights Management (DRM), the owner of a computer system is motivated to break the system security to make illegal copies of protected digital content.

Similarly, mobile agent applications require that sensitive electronic transactions be performed on untrusted hosts. The hosts may be under the control of an adversary who is financially motivated to break the system and alter the behavior of a mobile agent. Therefore, physical security is essential for enabling many applications in the Internet era.

Conventional approaches to build physically secure systems are based on building processing systems containing processor and memory elements in a private and tamper-proof environment that is typically implemented using active intrusion detectors. Providing high-grade tamper resistance can be quite expensive. Moreover, the applications of these systems are limited to performing a small number of security critical operations because system computation power is limited by the components that can be enclosed in a small tamper-proof package. In addition, these processors are not flexible, e.g., their memory or I/O subsystems cannot be upgraded easily.

Just requiring tamper-resistance for a single processor chip would significantly enhance the amount of secure computing power, making possible applications with heavier computation requirements. Secure processors have been recently proposed, where only a single processor chip is trusted and the operations of all other components including off-chip memory are verified by the processor.

To enable single-chip secure processors, two main primitives, which prevent an attacker from tampering with the off-chip untrusted memory, have to be developed: memory integrity verification and encryption. Integrity verification checks if an adversary changes a running program's state. If any corruption is detected, then the processor aborts the tasks that were tampered with to avoid producing incorrect results. Encryption ensures the privacy of data stored in the off-chip memory.

To be worthwhile, the verification and encryption schemes must not impose too great a performance penalty on the computation.

Given off-chip memory integrity verification, secure processors can provide tamper-evident (TE) environments where software processes can run in an authenticated environment, such that any physical tampering or software tampering by an adversary is guaranteed to be detected. TE environments enable applications such as certified execution and commercial grid computing, where computation power can be sold with the guarantee of a compute environment that processes data correctly. The performance overhead of the TE processing largely depends on the performance of the integrity verification.

With both integrity verification and encryption, secure processors can provide private and authenticated tamper resistant (PTR) environments where, additionally, an adversary is unable to obtain any information about software and data within the environment by tampering with, or otherwise observing, system operation. PTR environments can enable Trusted Third Party computation, secure mobile agents, and Digital Rights Management (DRM) applications.

### ACRONYMS, ABBREVIATIONS AND DEFINITIONS

| Acronym | Definition |
|---|---|
| OTFA EMIF4D | On The Fly AES EMIF |
| MAC | Message Authentication Code |
| GCM | Galois/Counter Mode |
| CCM | CBC-MAC + CTR |
| GHASH | Galois HASH |
| CBC-MAC | AES cipher-block chaining Message |
| | Authentication Code |
| AES | Advanced Encryption Standard |
| CTR | AES counter mode |
| ECB | AES electronic codebook mode |
| CBC | AES cipher-block chaining mode |

### SUMMARY OF THE INVENTION

An on the fly encryption engine is shown that is operable to encrypt data being written to a multi segment external memory, and is also operable to decrypt data being read from encrypted segments of the external memory. A Message Authentication Code (MAC) is also computed after memory writes and is written to the external memory with the encrypted data. During reads of an encrypted memory segment the MAC is again computed, and the results are compared with the MAC written during encrypted write operations. In case of a mismatch of the computed and the written MAC, an error is signaled to the processor indicating invalid data.

### BRIEF DESCRIPTION OF THE DRAWINGS

These and other aspects of this invention are illustrated in the drawings, in which:

FIG. 1 shows a block diagram of the invention.

FIG. 2 is a high level flow chart of the AES encryption standard,

FIG. 3 shows a high level block diagram of the on-the-fly encryption system,

FIG. 4 shows a block diagram of AES mode 0 processing, and

FIG. 5 is a block diagram of AES mode 1 processing.

### DETAILED DESCRIPTION OF PREFERRED EMBODIMENTS

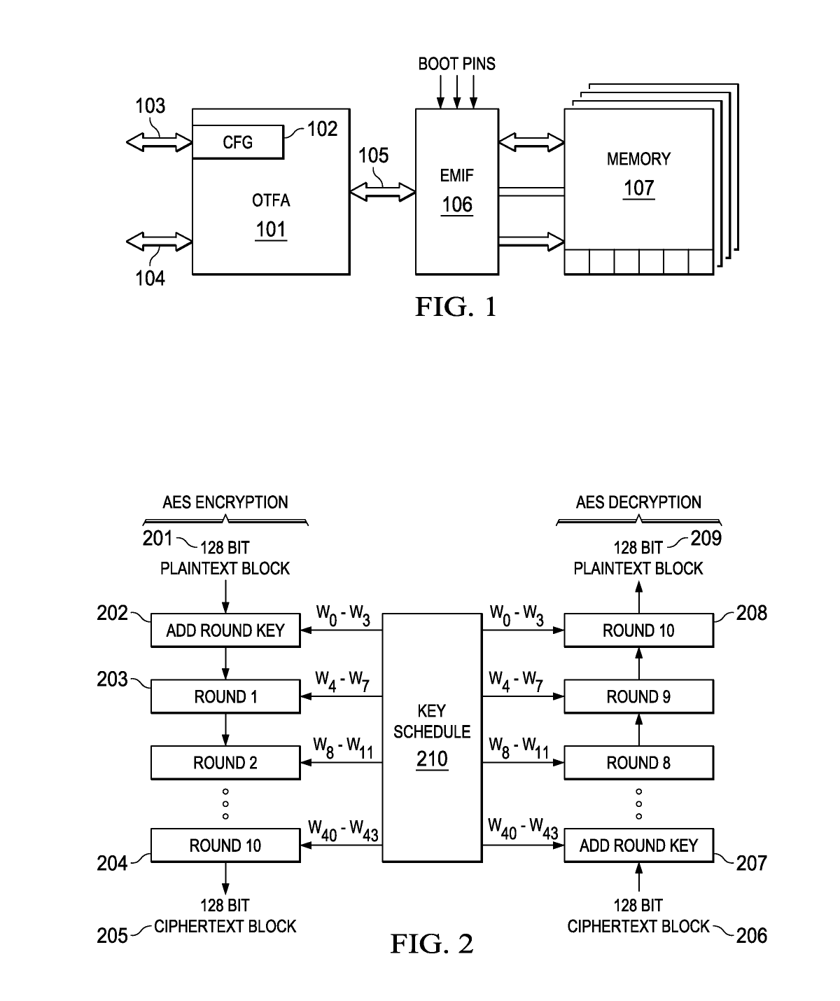

FIG. 1 shows the high level architecture of this invention. Block 101 is the on the fly encryption engine positioned between processor busses 103 and 14, and is connected to external memory interface 106 via bus 105. configuration data is loaded into configuration register 102 via bus 103, and unencrypted data is written/read to 101 via bus 104. Encrypted data is communicated to/from the External Memory Interface 106 via bus 105. External memory 107 is connected to and is controlled by 106. External memory 107 may be comprised of multiple memory segments. These segments may be unencrypted or encrypted, and the segments may be encrypted with distinct and different encryption keys.

While there is no restriction on the method of encryption employed, the implementation described here is based on the Advanced Encryption Standard (AES).

AES is a block cipher with a block length of 128 bits. Three different key lengths are allowed by the standard: 128, 192 or 256 bits. Encryption consists of 10 rounds of processing for 128 bit keys, 12 rounds for 192 bit keys and 14 rounds for 256 bit keys.

Each round of processing includes one single-byte based substitution step, a row-wise permutation step, a column-wise mixing step, and the addition of the round key. The order in which these four steps are executed is different for encryption and decryption.

The round keys are generated by an expansion of the key into a key schedule consisting of 44 4-byte words.

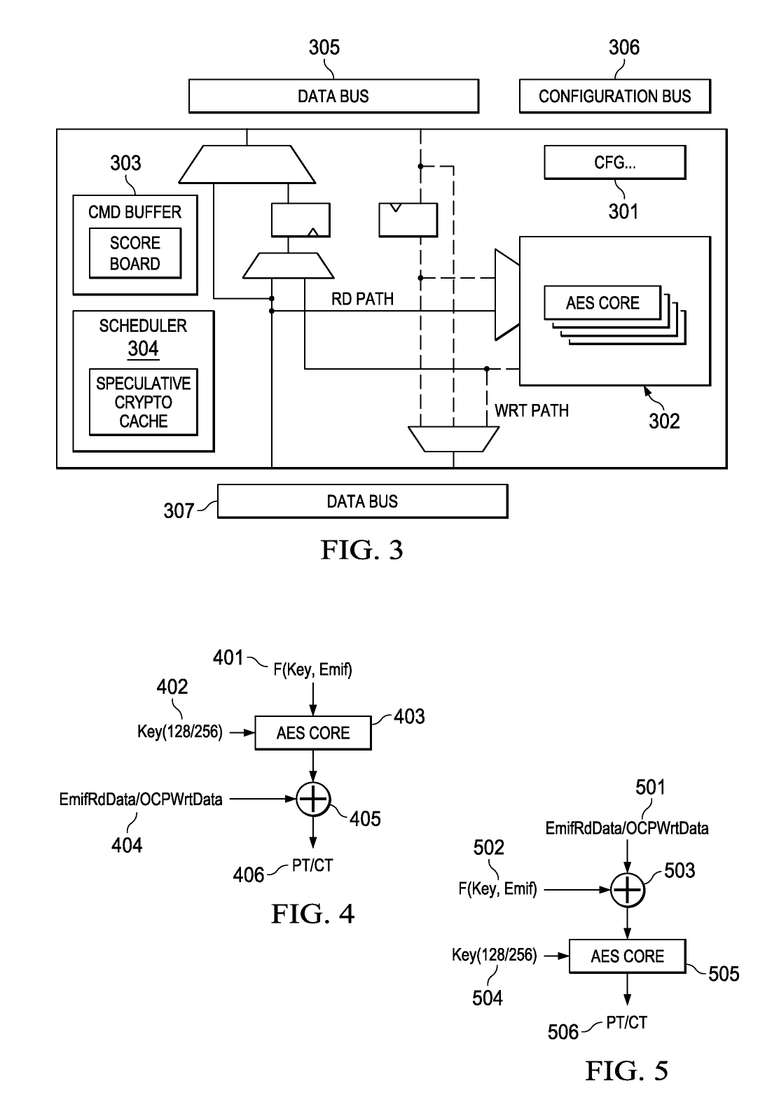

FIG. 2 shows the overall structure of AES using 128 bit keys. The round keys are generated in key scheduler 210. During encryption, 128 bit plain text block 201 is provided to block 202 where the first round key is added to plaintext block 201. The output of 201 is provided to block 203 where the first round is computed, followed by rounds 2 through round 10 in block 204. The output of block 204 is the resultant 128 bit cipher text block.

During decryption the 128 bit cipher text block 206 is provided to 207, where it is added to the last round key—the round key used by round 10 during encryption. This operation is followed by computing rounds 1 through 10 using the appropriate round keys in reverse order than their use during encryption. The output of 208, round 10 is the 128 bit plain text block 209.

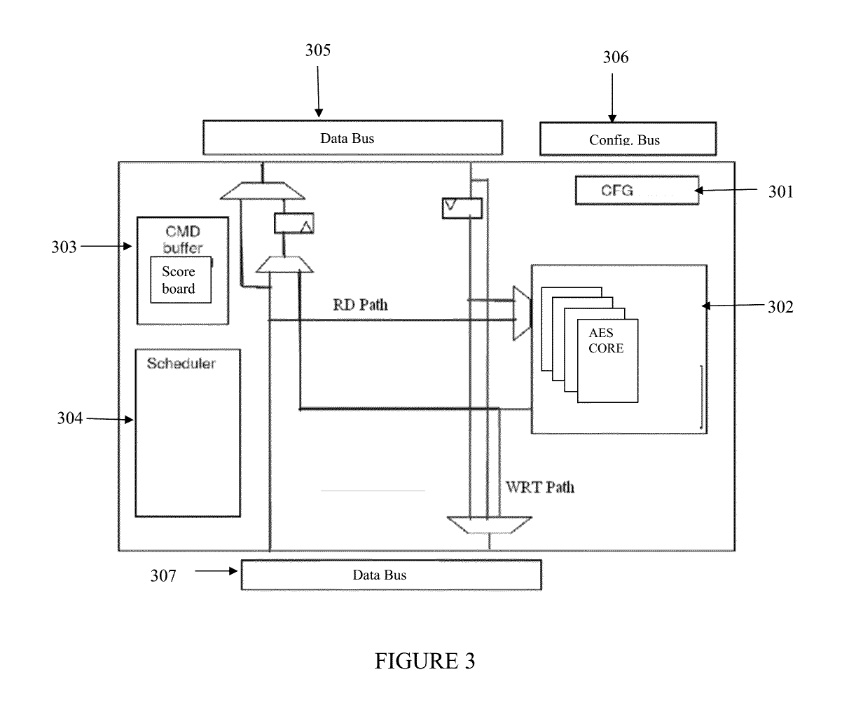

FIG. 3 is a high level block diagram of the on the fly encryption/decryption function. Plaintext to be encrypted during memory write operations is provided on data bus 305, with decrypted plaintext output on the same bus 305 during memory reads. Configuration data is provided on bus 306. Encrypted data bus 307 interfaces to the external memory controller.

Configuration data is input from bus 306 to the configuration block 301. AES core block 302 contains 12 AES cores and 6 GMAC cores which perform the cryptographic work.

This block performs the appropriate AES/GMAC/CBC-MAC operation defined by the scheduler.

Half of the AES and GMAC cores are assigned to RD path and the other half to the WRT path.

Since GMAC cores operate twice has fast as the AES cores, therefore half as many are required.

The AES operations have 2 modes of operations called AES CTR and ECB+.

AES CTR is optimized for write once and read <n> times per unique Key update.

ECB+ is optimized for write <n> and read <n> times per unique Key update.

Command Buffer Block 303 tracks and stores all active transactions by accepting new transactions submitted on the data bus 305. It tracks the External Memory Interface (EMIF) responses to the submitted commands to the EMIF. With this information OTFA_EMIF has the ability to determine which command is associated with the EMIF response. This is required to determine which command and address is associated with the read data the EMIF is presenting.

Scheduler block 304 is the main control block which controls
Data path routing
AES/MAC operations
Read/Modify/write operations

Data path routing is simple routing of the data sources for the AES operation. There are 2 possible data sources, the input write data and EMIF read data. Read data is required for read transactions or write transactions that require an internal read modify write operation.

The scheduler block will issue an internal Read Modify Write operation during the following conditions:

During ECB+ write operation when any of the byte enables are not active for each 16 Byte transfer.

During write operation when MAC is enabled and the block being written is not a complete 32 Byte transfer.

The scheduler block will issue a modified Read command when accessing a MAC enabled region when the Read command is not a multiple of 32 Bytes. These operations are shown in Table 1.

TABLE 1

| System | |
|---|---|
| Transaction | Action |
| Write using | On this first detection of a missing byte |
| ECB+ mode and | enable, OTFA will nullify all byte enables |
| not all 16 Bytes | for the complete transaction, mask the emif |
| are enabled | response, issue a Read cmd to build the |
| | complete block, then create a new write |
| | data block and issue a new write command, |
| | the response of this new command will cause |
| | a response of the original write command |
| Write using MAC | Same as above |
| modes and not | |
| all 32 Bytes are | |
| enabled | |
| Read using MAC | The Read operation will get extend to align |
| modes and size | to 32 Bytes. |
| is not in | The system response will appear to be the |
| multiplies of | original size. |
| 32 Bytes | |

During encryption, the scheduler will first determine if this address is in a Crypto Region, if not then bypass the Crypto Cores.

If the address is a hit for Crypto operation, it determines the type of operation based on the Encryption mode and Authentication mode for that region.

It will then schedule the required Crypto tasks for the Crypto Cores to implement that function including the HASH calculation.

It checks to see if a read/modify/write is required, then schedule a appropriate command.

During decryption the scheduler will first determine if this address is in a Crypto Region, if not then bypass the Crypto Cores.

If the address is a hit for Crypto operation, it determines the type of operation based on the Encryption mode and Authentication mode for that region.

Based on this information it will determine if it can start an early Crypto operation before the command is sent to the memory and before the read data is returned by the memory. This early operation enables high performance since the Crypto operation is started before the read data is sent back.

Also, it will check the HASH CACHE to determine if this command has a HIT, if a MISS the it will issue a HASH read before the read command is sent.

When the RD_DATA is sent back, a Scoreboard is used to determine which command it was associated with, this allows out of order commands to the external memory and out of order read data from the memory.

Once the read data arrives, the data will get sent to the Crypto Cores for processing.

For some types of Crypto Operations a Speculative Read Crypto operation can start when the Read command is sent to the Memory System. The result of this operation is stored in a Speculative Read Crypto Cache which enables the out of order response from the Memory System.

The Crypto Cores are a set of cores which can get used by encryption or decryption operations. The interface is simple, FIFO like with backpressure. If read traffic is 50% and write traffic is 50% then the allocation can be balanced. If write traffic is higher more Crypto Cores may be allocated to the write traffic.

This can get done by a static allocation, like a 60 to 40 split or it can get done by a dynamic allocation to adapt to the current traffic patterns. This will insure the maximum utilization of the Crypto Cores.

The region checking function will verify that a command will not cross memory regions. If regions are crossed the command will be blocked. For WR DATA it will null all byte enables. For RD DATA will force zero on all DATA. A secure Error event is sent to the kernel. This prevents bad or malicious code from corrupting a secure area or getting access to a secure area.

The dictionary checker function will verify that the command is not doing a Dictionary attack by accessing the same memory location multiple times. If it violates these rules it will block the WR command from issuing a Crypto Operation and will null all byte enables. A secure Error event is sent to the kernel. This prevents bad or malicious code from determining the Crypto Keys used making the brute force attack the only possible method to break the encryption.

AES block 302 requires the following inputs:
Address of data word (from the command or calculated for a burst command),
AES mode along with the Key size, Key and Initialization Vector (IV),
Read or Write transaction type

The AES operation produces an encrypted or decrypted data word.

The MAC operation produces a MAC for Read and Write operations.

Table 2 defines the possible combinations of Encryption modes and Authentication modes. A total of 9 combinations are allowed. Note GCM is AES-CTR+GMAC and CCM is AES-CTR+CBC-MAC.

TABLE 2

| Authentication modes | | Encryption modes | |
|---|---|---|---|
| Disable | Disable | AES-CTR | AES-ECB+ |
| GMAC | Supported | Supported | Supported |
| CBC-MAC | Supported | Supported | Not Supported |
| | Not Supported | Supported | Not Supported |

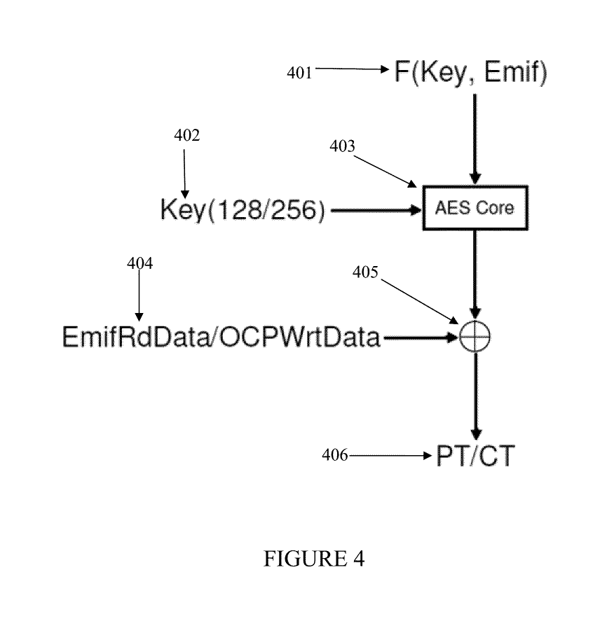

AES mode 0 is shown in FIG. 4. The inputs to AES core 403 are the Input data 401 generated by scheduler 304 and the encryption/decryption key 402. The output of AES core 403 and the EMIF read data during decryption or the bus write data during encryption is combined by Exclusive Or block 405. The output of 405 is either cipher text during encryption, or plain text during decryption. AES mode 0 does not require a Read Modify Write operation.

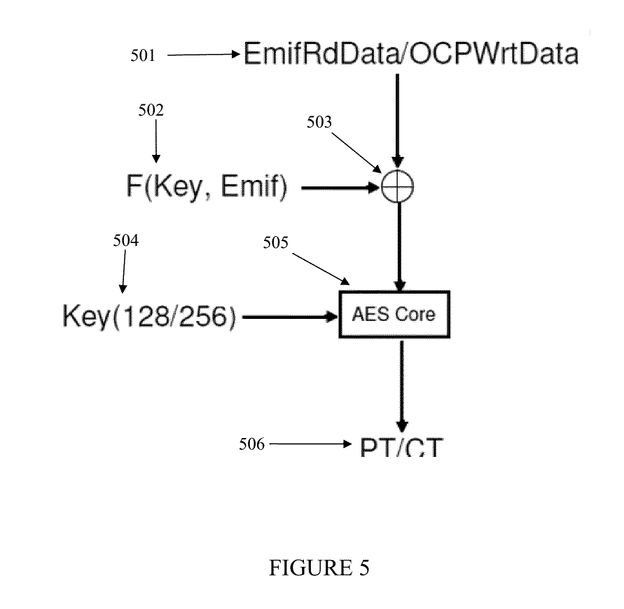

AES mode 1 is shown in FIG. 5. 501 read data from the EMIF during decryption or write data from the bus during encryption is combined in XOR block 503 with the data 502 generated by scheduler 304. The output of the XOR block 503 is input to AEA core 505, together with the encryption or decryption key 504. Output 506 of the AES core 505 is plain text during decryption, or cipher text during encryption.

What is claimed is:

1. A data encryption system comprising:
a data bus operable to provide plain text data to be encrypted to the data encryption system, and further operable to receive decrypted plain text data from the encryption system,
a data encryption system operable to encrypt said plain text data, and further operable to decrypt data that has been previously encrypted,
an external memory interface operable to receive encrypted data from said data encryption system and write the encrypted data to a random access memory, and further operable to receive encrypted data from said random access memory and provide it to the data encryption system,
a random access memory comprising of one or more memory segments, connected to said external memory interface.

2. The data encryption system of claim 1, further comprising:
a plurality of encryption cores operable to perform a variety of encryption, decryption or message authentication functions.

3. The data encryption system of claim 2, wherein:
said encryption cores are operable to encrypt or decrypt data according to the Advanced Encryption Standard.

4. The data encryption system of claim 2, wherein:
said encryption cores are operable to compute a Message Authentication Code.

5. The data encryption system of claim 2, wherein:
the encryption cores are dynamically allocated to perform encryption, decryption or message authentication code generation according to system performance requirements.

6. The data encryption system of claim 2, wherein:
the number of encryption cores allocated to perform encryption, decryption or message authentication code generation is dynamically adjusted to match system requirements.
